(19) United States
(12) Patent Application Publication
(10) Pub. No.: US 2007/0187953 A1
(43) Pub. Date: Aug. 16, 2007

(54) Air conditioner compressor united with starter motor

(76) Inventor: Man Hee Park, Suwon-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/635,888

(22) Filed: Dec. 7, 2006

(30) Foreign Application Priority Data
Feb. 10, 2006 (KR) 10-2006-0097006

(51) Int. Cl. B60L 11/02

(52) U.S. Cl. 290/28

(57) ABSTRACT

An air conditioner compressor united with a starter motor includes: a drive portion including a motor and a drive shaft, a refrigerant compressing portion for compressing a refrigerant by a rotational force of the motor driven by a battery power source applied through a compressor relay, a power transmission device for transmitting a rotational force of the drive shaft to an engine crank shaft when the motor is driven, and a clutch device for controlling the rotational force between the drive shaft and the power transmission means. The motor and the clutch device are connected to a starter relay and receive the battery power source when starting an engine such that the motor and the clutch device operate when the starter relay is turned on to transmit the rotational force to the engine crank shaft through the drive shaft and the power transmission device, thus starting the engine.

### CROSS-REFERENCE TO RELATED APPLICATION

This application claims the benefit of Korean Patent Application No. 10-2006-0097006, filed on Oct. 2, 2006, the entire disclosure of which is hereby incorporated by reference.

### BACKGROUND OF THE INVENTION

1. Field of the Invention

The present invention relates to an air conditioner compressor united with a starter motor and, more particularly, to an air conditioner compressor with a starter motor function for an starting engine.

2. Description of Related Art

In a parallel type hybrid electric vehicle, which is widely used in passenger cars, the engine both charges the battery and drives the vehicle along with the electric motor.

The hybrid electric vehicle is driven by the power sources of the engine and the electric motor according to various conditions through the coordinated control between controllers, such as, for example, an engine control unit (ECU) controlling the overall operation of the engine, a motor control unit (MCU) controlling the overall operation of the electric motor, a transmission control unit (TCU) controlling the transmission, a battery management system (BMS) controlling the operation of the battery, a full auto temperature controller (FATC) taking charge of the room temperature control, etc. are included in the hybrid electric vehicle.

In addition, a starter motor driven by the battery starts the engine in the same manner as in other kinds of vehicles, such as gasoline engine vehicles, etc.

When a driver turns the ignition key to the “START” position, the starter motor receives power from the battery and generates torque for engine cranking. The rotational force of the starter motor is typically transmitted to a ring gear of a fly wheel to rotate a crank shaft, thus starting the engine.

After starting the engine, if the ignition key is returned to the “ACC” position, the power supply to the starter motor is shut off.

The starter motor in hybrid electric vehicles, like those in other vehicles, serves only to start the engine.

An air conditioner in a hybrid electric vehicle, like that in other vehicles, includes a compressor for compressing a refrigerant. The power for driving the compressor is supplied by the engine; however, if it were driven only by the engine, when the engine was shut down in an electric mode, in which the vehicle is driven only by the electric motor, the air conditioner would shut off.

Accordingly, the hybrid electric vehicle may include an electric compressor, in which a motor driven by the battery is mounted in the compressor. A drive shaft of the compressor, connected with the motor, rotates when the motor is driven by the battery power source.

The above information disclosed in this Background section is only for enhancement of understanding of the background of the invention and therefore it may contain information that does not form the prior art that is already known in this country to a person of ordinary skill in the art.

### SUMMARY OF THE INVENTION

An air conditioner compressor united with a starter motor includes: a drive portion including a motor and a drive shaft, a refrigerant compressing portion for compressing a refrigerant by a rotational force of the motor driven by a battery power source applied through a compressor relay, a power transmission device for transmitting a rotational force of the drive shaft to an engine crank shaft when the motor is driven, and a clutch device for controlling the rotational force between the drive shaft and the power transmission means. The motor and the clutch device are connected to a starter relay and receive the battery power source when starting an engine such that the motor and the clutch device operate when the starter relay is turned on to transmit the rotational force to the engine crank shaft through the drive shaft and the power transmission device, thus starting the engine.

The power transmission device may include: a drive pulley mounted with an intermediating bearing on the drive shaft, through which the rotational force transmission with the drive shaft is controlled by the clutch device; a crank shaft pulley mounted on the crank shaft; and a belt connecting the drive pulley and the crank shaft pulley.

The clutch device may include: a coil, disposed on the drive pulley and connected with the starter relay, though which the battery power source is supplied when turning on the starter relay; and a clutch, spline-connected with the drive shaft to rotate along with the drive shaft, and configured to be engaged with the drive pulley when the battery power source is supplied to the coil.

### BRIEF DESCRIPTION OF THE DRAWINGS

FIG. 1 is a schematic diagram showing an air conditioner compressor united with a starter motor in accordance with embodiments of the present invention;

FIG. 2 is a circuit diagram of an air conditioner compressor united with a starter motor in accordance with embodiments of the present invention; and

FIG. 3 is a state diagram depicting the operation when an engine starts in the air conditioner compressor united with a starter motor in accordance with embodiments of the present invention.

### DETAILED DESCRIPTION OF THE PREFERRED EMBODIMENTS

The present invention provides an air conditioner compressor united with a starter motor and a technique for starting an engine using an air conditioner compressor motor that compresses refrigerant.

The present invention transmits the rotational force of the motor to the crank shaft during the starting operation.

Exemplary embodiments of the present invention further provide a power transmission means for transmitting the rotational force of the drive shaft to the crank shaft, and a clutch means for controlling the rotational force between the drive shaft and the power transmission means, such that the crank shaft is rotated by the drive power of the compressor motor only if the driver turns the ignition key to the “start” position.

The power transmission means may comprise a drive pulley mounted with an intermediating bearing on the drive shaft, a crank shaft pulley mounted on the crank shaft and a belt connected between the drive pulley and the crank shaft pulley.

The clutch means may comprise a coil on the drive pulley, and a clutch, spline-connected with the drive shaft such that it rotates along with the drive shaft, for transmitting the rotational force along with the drive pulley by electromagnetic force when an electric power is applied to the coil.

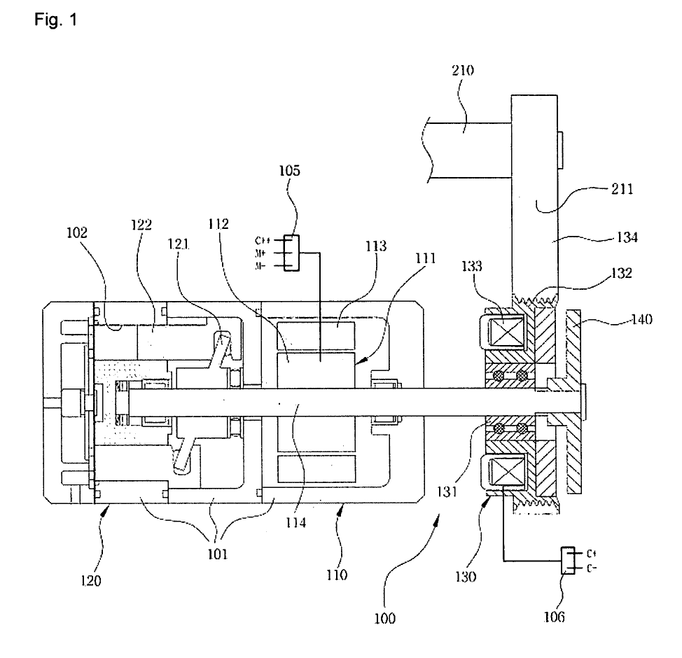

Referring to FIG. 1, exemplary embodiments of the present invention provide a motor 111 rotating a drive shaft 114 mounted at one side of a compressor housing 101 of an electrical air conditioner compressor 100. With the drive of the motor 111, the drive shaft 114 rotates to compress a refrigerant.

The compressor 100 further includes a refrigerant compressing portion 120 at one side of the compressor housing 101 and a drive portion 110 at the other side of the compressor housing 101. The motor 111 is mounted in the drive portion 110 and the drive shaft 114 is disposed in the longitudinal direction in the compressor housing 101. A swash plate 121 is mounted on the drive shaft 114 extending to the refrigerant compressing portion 120 and pistons 122 sliding in chambers 102 in response to the motion of swash plate 121 to compress the refrigerant are provided in the swash plate 121.

The motor 111 may be fabricated using a coil (not shown) and further includes a rotor 112 installed on the drive shaft 114, a permanent magnet (not shown), and a stator 113 arranged around the rotor 112.

The swash plate 121 of the refrigerant compressing portion 120 rotates along with the rotation of the drive shaft 114 and, with the rotation of the swash plate 121, the pistons 122 slide to compress the refrigerant.

While a swash plate type refrigerant compressing portion 120 is shown in the Figs, it is possible to adopt various types of refrigerant compressing portions, such as, for example and without limitation, scroll type, wobble plate type, or vane rotary type.

The motor 111 is driven by receiving battery power through a motor connector 105. The drive shaft 114 rotates by the drive of the motor 111 by the electric power supplied through the motor connector 105.

If the drive shaft 114 rotates as the electric power is applied to the motor 111, the swash plate 121 rotates along with the drive shaft 114 and the pistons 122 slide in the chambers 102 to compress the refrigerant. That is, when the electric power is supplied through the motor connector 105 to drive the motor 111, the refrigerant compressing portion 120 operates by the rotational force transmitted through the drive shaft 114, thus resulting in refrigerant compression.

In addition, a clutch 140 is mounted on an end opposite the refrigerant compressing portion 120 and extends from the drive shaft 114 to the outside of the compressor housing 101, and a pulley-coil assembly 130 is mounted with an intermediating bearing 131 on the drive shaft 114, and is spaced apart from the clutch 140.

The clutch 140 rotates along with the drive shaft 114 and transmits the rotational force of the drive shaft 114 to the pulley-coil assembly 130, if it is connected with the pulley-coil assembly 130. Accordingly, the pulley-coil assembly 130 rotates along with the drive shaft 114 and the clutch 140.

Moreover, a drive pulley 132 of the pulley-coil assembly 130 is connected to a belt 134 to transmit the power to an engine crank shaft pulley 211 and, as a result, when the rotational force of the drive shaft 114 is transmitted to the pulley-coil assembly 130, the rotational force is transmitted to the crank shaft pulley 211 through the belt 134 to rotate a crank shaft 210, thus starting the engine.

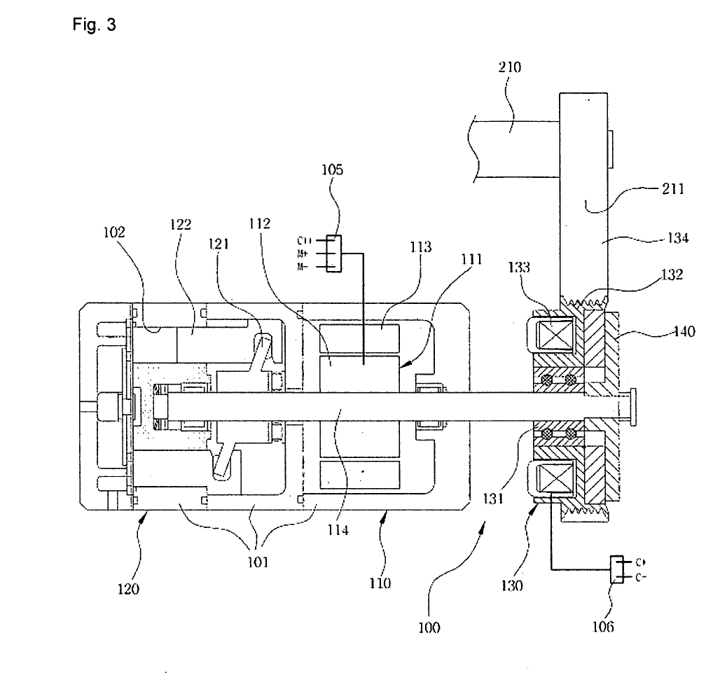

The pulley-coil assembly 130 receives the battery power source through a coil connector 106. If electric power is supplied to a coil 133 of the pulley-coil assembly 130 through the coil connector 106, the drive pulley 132 becomes electromagnetized and the clutch 140 is pulled toward and comes into contact with the drive pulley 132 (from the position seen in FIG. 1 to the position seen in FIG. 3), thus transmitting the rotational forces of the drive shaft 114 and the clutch 140 to the pulley-coil assembly 130.

Consequently, when starting the engine, the electric power is supplied through the motor connector 105 to drive the motor 111 and, at the same time, the electric power is supplied through the coil connector 106 to connect the clutch 140 with the pulley-coil assembly 130. The rotational force of the motor 111 is transmitted to the drive shaft 114, the clutch 140, the pulley-coil assembly 130, the belt 134, the crank shaft pulley 211 and the crank shaft 210 in turn, thus starting the engine.

When driving the air conditioner after starting the engine, the electric power is supplied through the motor connector 105 to drive the motor 111; however, the electric power is not supplied through the coil connector 106. Accordingly, the drive shaft 114 rotates under the condition that the clutch 140 is spaced apart from the pulley-coil assembly 130, thus resulting in the refrigerant compression.

If the motor 111 is driven under the condition that the clutch 140 is spaced apart from the pulley-coil assembly 130, the drive shaft 114 rotates to compress the refrigerant in the refrigerant compressing portion 120 and the rotational force is not transmitted from the drive shaft 114 to the pulley-coil assembly 130. If the motor 111 is not driven, the pulley-coil assembly 130 rotates by the rotation of the crank shaft 210 after starting the engine, however, it rotates in an idle state, not resulting in refrigerant compression.

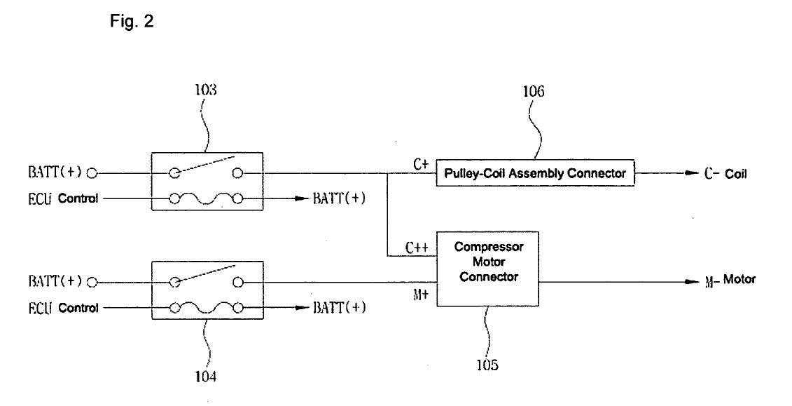

Referring to FIG. 2, in which reference numeral 103 denotes a starter relay that is turned on by the operation of the start key when starting engine, and numeral 104 denotes a compressor relay that is turned on by the operation of the air conditioner switch when operating the air conditioner, the output end of the contact point of the starter relay 103 is linked to both input ends (C⁺ and C⁺⁺) of the coil connector 106 and the motor connector 105, whereas, the output end of the contact point of the compressor relay 104 is coupled only to an input end (M⁺) of the motor connector 105.

When turning the ignition key to the “START” position, the starter relay 103 is turned on by the control signal of the engine control unit. The battery power source is supplied to the coil connector 106 and the motor connector 105 through the contact point at the same time, thus operating the motor 111 and the clutch 140.

In this case, as described above, the rotational force of the motor 111 is transmitted to the crank shaft 210 of the engine, thus resulting in the engine start.

Here, the refrigerant compressing portion 120 is driven for a short time during the engine start, and after starting the engine the starter relay 103 is turned off to cut off the electric power of the motor 111 and the clutch 140 (ignition key located at the “ACC” position).

Moreover, the compressor relay 104 is turned on by the control signal of the air conditioner controller, if turning on the air conditioner switch. Here, the battery power source is supplied through the contact point to the motor connector 105 and, accordingly, the electric power is supplied to the motor connector 105 to drive the motor 111. As a result, the compressor compresses the refrigerant, thus operating the air conditioner.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An air conditioner compressor united with a starter motor comprising:
a drive portion comprising a motor mounted at a first side of a housing and a drive shaft;
a refrigerant compressing portion, disposed at a second side of the housing, for compressing a refrigerant by a rotational force of the motor driven by a battery power source applied through a compressor relay;
a power transmission device for transmitting a rotational force of the drive shaft to an engine crank shaft when the motor is driven; and
a clutch device for controlling the rotational force between the drive shaft and the power transmission means; wherein
the motor and the clutch device are connected to a starter relay and receive the battery power source when starting an engine such that the motor and the clutch device operate when the starter relay is turned on to transmit the rotational force to the engine crank shaft through the drive shaft and the power transmission device, thus starting the engine.

2. The air conditioner compressor united with a starter motor as recited in claim 1, wherein the power transmission device comprises:
a drive pulley mounted with an intermediating bearing on the drive shaft, through which the rotational force transmission with the drive shaft is controlled by the clutch device;
a crank shaft pulley mounted on the crank shaft; and
a belt connecting the drive pulley and the crank shaft pulley.

3. The air conditioner compressor united with a starter motor as recited in claim 2, wherein the clutch device comprises:
a coil, disposed on the drive pulley and connected with the starter relay, though which the battery power source is supplied when turning on the starter relay; and
a clutch, spline-connected with the drive shaft to rotate along with the drive shaft, and configured to be engaged with the drive pulley when the battery power source is supplied to the coil.
